(19) United States
(12) Patent Application Publication
(10) Pub. No.: US 2017/0306448 A1
(43) Pub. Date: Oct. 26, 2017

(54) ALPHA-BETA TITANIUM ALLOYS HAVING ALUMINUM AND MOLYBDENUM, AND PRODUCTS MADE THEREFROM

(71) Applicant: ARCONIC, INC., Pittsburgh, PA (US)

(72) Inventors: Jen C. Lin, Export, PA (US); Xinyan Yan, Murrysville, PA (US); Joseph C. Sabol, Aspinwall, PA (US); David W. Heard, Pittsburgh, PA (US); Faramarz MH Zarandi, Pittsburgh, PA (US); Severine Cambier, Pittsburgh, PA (US); Fusheng Sun, Canfield, OH (US); Ernest M. Crist, JR., Transfer, PA (US); Sesh A. Tamirisakandala, Solon, OH (US)

(21) Appl. No.: 15/496,589

(22) Filed: Apr. 25, 2017

Related U.S. Application Data
(60) Provisional application No. 62/327,300, filed on Apr. 25, 2016.

(51) Int. Cl. C22C 14/00; B23K 15/00; B33Y 70/00; B33Y 10/00; B22F 3/105; B23K 26/342; C22F 1/18; B23K 26/00; B23K 103/14

(52) U.S. Cl. CPC C22C 14/00; C22F 1/183; B23K 15/0086; B33Y 70/00; B23K 26/0006; B23K 15/0093; B33Y 10/00; B22F 3/1055; B23K 26/342; B22F 2301/205; B23K 2203/14

(57) ABSTRACT

New alpha-beta titanium alloys are disclosed. The new alloys generally include 7.0-11.0 wt. % Al, and 1.0-4.0 wt. % Mo, wherein Al:Mo, by weight, is from 2.0:1-11.0:1, the balance being titanium, any optional incidental elements, and unavoidable impurities. The new alloys may realize an improved combination of properties as compared to conventional titanium alloys.

### CROSS-REFERENCE TO RELATED APPLICATIONS

This patent application claims priority to International Patent Application No. PCT/US2017/029197, filed Apr. 24, 2017, entitled “ALPHA-BETA TITANIUM ALLOYS HAVING ALUMINUM AND MOLYBDENUM, AND PRODUCTS MADE THEREFROM”, and claims benefit of priority of U.S. Provisional Patent Application No. 62/327,300, filed Apr. 25, 2016, entitled “BCC MATERIALS OF TITANIUM, ALUMINUM, AND MOLYBDENUM, AND PRODUCTS MADE THEREFROM”, each of which is incorporated herein by reference in its entirety.

### BACKGROUND

Titanium alloys are known for their low density (60% of that of steel) and their high strength. Additionally, titanium alloys may have good corrosion resistant properties. Pure titanium has an alpha (hcp) crystalline structure.

### SUMMARY OF THE DISCLOSURE

Broadly, the present patent application relates to new alpha-beta titanium alloys made from titanium, aluminum, and molybdenum having a single phase field of a body-centered cubic (bcc) solid solution structure immediately below the liquidus temperature of the material (“the new materials”). As known to those skilled in the art, and as shown in FIG. 1, a body-centered cubic (bcc) unit cell has atoms at each of the eight corners of a cube plus one atom in the center of the cube. Each of the corner atoms is the corner of another cube so the corner atoms are shared among eight unit cells. Due to the unique compositions described herein, the new materials may realize a single phase field of a bcc (beta) solid solution structure immediately below the liquidus temperature of the material, with hcp phase (alpha) forming during subsequent cooling. The new materials may also have a high liquidus point and a narrow equilibrium freezing range (e.g., for restricting microsegregation during solidification), making them suitable for production through conventional ingot processing, as well as powder metallurgy, shape casting, additive manufacturing, and combinations thereof (hybrid processing). The new materials may find use in high temperature applications.

The new materials generally include 7.0-11.0 wt. % Al, 1.0-4.0 wt. % Mo, where the weight ratio of aluminum to molybdenum is from 2.0-11.0, the balance being titanium, incidental elements, and unavoidable impurities, wherein the material includes a sufficient amount of the titanium, aluminum, and molybdenum to realize the alpha-beta crystalline structure. The below table provides some non-limiting examples of useful new alloy materials.

TABLE 1
Example Titanium Alloys

| Ex. Alloy | Al (wt. %) | Mo (wt. %) | Al:Mo (wt.) | Balance |
|---|---|---|---|---|
| Alloy 1 | 7.0-11.0 | 1.0-4.0 | 2.0:1-11.0:1 | Ti, any incidental |
| | | | | elements and |
| | | | | impurities |
| Alloy 2 | 7.0-10.5 | 1.0-3.5 | 2.0:1-10.0:1 | Ti, any incidental |
| | | | | elements and |
| | | | | impurities |
| Alloy 3 | 7.0-10.0 | 1.0-3.0 | 2.33:1-10.0:1 | Ti, any incidental |
| | | | | elements and |
| | | | | impurities |
| Alloy 4 | 7.0-9.5 | 1.5-3.0 | 2.33:1-6.33:1 | Ti, any incidental |
| | | | | elements and |
| | | | | impurities |
| Alloy 5 | 7.0-9.0 | 1.5-2.5 | 2.8:1-6.0:1 | Ti, any incidental |
| | | | | elements and |
| | | | | impurities |

As used herein, “alloying elements” means the elements of titanium, aluminum and molybdenum of the alloy. As used herein, “incidental elements” includes grain boundary modifiers, casting aids, and/or grain structure control materials, and the like, that may be used in the alloy, such as silicon, iron, yttrium, erbium, carbon, oxygen, and boron. In one embodiment, the materials may optionally include a sufficient amount of one or more of the following elements to induce additional precipitates at elevated temperatures:
Si: up to 1 wt. %
Fe: up to 2 wt. %
Y: up to 1 wt. %
Er: up to 1 wt. %
C: up to 0.5 wt. %
O: up to 0.5 wt. %
B: up to 0.5 wt. %
   While the amount of such optional additional element(s) in the material should be sufficient to induce the production of strengthening precipitates, the amount of such optional additional element(s) should also be restricted to avoid primary phase particles.

The new materials may have a high beta (β) transus temperature and/or a low Ti₃Al (α2) solvus temperature, which may result in improved thermal stability of the hcp (α) phase, which may improve the strength of the material at elevated temperatures. The new materials may have a narrow freezing range, which may result in restricted (or no) hot cracking and/or microsegregation. Indeed, as shown in FIGS. 2a-2b and Tables 1-2, below, the new alloys may solidify almost like a pure metal that has an invariant temperature with coexisting liquid and solid.

Tables 1-2 provide some non-limiting examples of liquidus temperature, solidus temperature, equilibrium freezing range, non-equilibrium freezing range, beta transus temperature, solvus temperature, precipitate phase(s), and density for an invention alloy.

TABLE 1
Additional Example Alloys (Calculated)

| | | | | Approx. | |
|---|---|---|---|---|---|
| | | | Approx. | Non- | |
| | Approx. | | Equil. | Equil. | |
| | Liq- | Approx. | Freezing | Freezing | |
| | uidus | Solidus | Range | Range | Matrix |
| Alloy | (° C.) | (° C.) | (° C.) | (° C.) | Phase |
| Ti—8Al—2Mo | 1689 | 1688 | 1 | 4 | Beta + alpha |
| Ti—7Al—4Mo | 1691 | 1685 | 6 | 6 | Beta + alpha |
| (Prior art) | | | | | |

TABLE 2
Additional Example Alloys (cont.)

| | Approx Beta | Precipitate | Approx. | Density |
|---|---|---|---|---|
| Alloy | transus (° C.) | Phase | Solvus (° C.) | (g/cm³) |
| Ti—8Al—2Mo | 1026 | Ti₃Al (α2) | 765 | 4.23 |
| Ti—7Al—4Mo | 998 | Ti₃Al (α2) | 790 | 4.40 |
| (Prior art) | | | | |

FIG. 2b shows the effect of Al content on alloy freezing range for a Ti-2Mo-XAl alloy. As shown, the alloy has a narrow freezing range, particularly at 10 wt. % Al. In general, the equilibrium freezing range is narrower than approximately 1° C. if the Al content is from 7 to 11 wt. %. The effect of Al content on the equilibrium phase fields for a Ti-2Mo-XAl alloy in the solid state is shown in FIG. 2c. The stability of the hcp (α) phase and the Ti₃Al (α2) phase increases with increasing Al content. The increased hcp (α) phase stability may increase the strength of new alloys at elevated temperatures. However, the increased Ti₃Al (α2) phase may reduce ductility of the alloy. In one embodiment, an alloy includes not greater than 10.5 wt. % Al. In another embodiment, an alloy includes not greater than 10.0 wt. % Al. In yet another embodiment, an alloy includes not greater than 9.5 wt. % Al. In another embodiment, an alloy includes not greater than 9.0 wt. % Al. In one embodiment, an alloy includes 7-9 wt. % Al.

The effect of Mo content on the equilibrium freezing range of a Ti-8Al-XMo alloy is given in FIG. 2d. As shown, the freezing range is not affected significantly by the Mo content from 1 to 4 wt. %. In one embodiment, an alloy includes not greater than 3.5 wt. % Mo. In another embodiment, an alloy include not greater than 3.0 wt. % Mo. In yet another embodiment, an alloy includes not greater than 2.5 wt. % Mo In one embodiment, an alloy includes at least 1.5 wt. % Mo. In one embodiment, an alloy contains from 1 to 3 wt. % Mo. In one embodiment, an alloy contains from 1.5 to 2.5 wt. % Mo. FIG. 2e shows the effect of Mo on the equilibrium phase fields of a Ti-8Al-XMo alloy in the solid state. As shown, the hcp (α) phase is destabilized, but the Ti₃Al (α2) phase is stabilized with increasing Mo content in the alloy. The hcp (α) phase may increase the alloy strength and stability at elevated temperatures, but the Ti₃Al (α2) phase might decrease the ductility of the alloy.

The weight ratio of aluminum to molybdenum should also be maintained from 2.0:1-11.0:1, for instance, to facilitate improved castability in combination with improved high temperature properties. In one embodiment, the weight ratio of Al:Mo is at least 2.33:1. In another embodiment, the weight ratio of Al:Mo is at least 2.5:1. In yet another embodiment, the weight ratio of Al:Mo is at least 2.8:1. In another embodiment, the weight ratio of Al:Mo is at least 3.0:1. In one embodiment, the weight ratio of Al:Mo is not greater than 10.0. In another embodiment, the weight ratio of Al:Mo is not greater than 9.0:1. In yet another embodiment, the weight ratio of Al:Mo is not greater than 8.0:1. In another embodiment, the weight ratio of Al:Mo is not greater than 7.0:1. In another embodiment, the weight ratio of Al:Mo is not greater than 6.5:1. In another embodiment, the weight ratio of Al:Mo is not greater than 6.33:1. In another embodiment, the weight ratio of Al:Mo is not greater than 6.0:1.

In one embodiment, a new material includes 7.0-11.0 wt. % Al, 1.0-3.0 wt. % Mo, the balance being titanium and unavoidable impurities, wherein the material includes a sufficient amount of the titanium, aluminum, and molybdenum to realize the alpha-beta crystalline structure, optionally with Ti₃Al (α2) therein.

In one approach, and referring now to FIG. 3, a method of producing a new material includes the steps of (100) heating a mixture comprising Ti, Al, and Mo, and within the scope of the compositions described above, above a liquidus temperature of the mixture, thereby forming a liquid, (200) cooling the mixture from above the liquidus temperature to below a solidus temperature, wherein, due to the cooling, the mixture first forms bcc, some of which transforms to hcp at or below the beta transus temperature, thereby realizing an alpha-beta solid solution structure, and (300) cooling the solid product to below a solvus temperature of precipitate phase(s) of the mixture, optionally thereby forming one or more precipitate phases within the alpha-beta structure of the solid product, wherein the mixture comprises a sufficient amount of the Ti, the Al, and the Mo to realize the alpha-beta structure, optionally with any precipitate phases therein. In one embodiment, the bcc solid solution is the first phase to form from the liquid. At the beta transus temperature, hcp (alpha) phase may form, thereby providing the alpha-beta crystalline structure.

In one embodiment, controlled cooling of the material is employed to facilitate realization of an appropriate end product. For instance, a method may include the step of (400) cooling the mixture to ambient temperature, and a method may include controlling rates of cooling during at least cooling steps (300) and (400) such that, upon conclusion of step (400), i.e., upon reaching ambient temperature, a crack-free ingot is realized. Controlled cooling may be accomplished by, for instance, using an appropriate water cooled casting mold.

As used herein, “ingot” means a cast product of any shape. The term “ingot” includes billet. As used herein, “crack-free ingot” means an ingot that is sufficiently free of cracks such that it can be used as a fabricating ingot. As used herein, “fabricating ingot” means an ingot suitable for subsequent working into a final product. The subsequent working may include, for instance, hot working and/or cold working via any of rolling, forging, extrusion, as well as stress relief by compression and/or stretching.

In one embodiment, a crack-free product, such as a crack-free ingot, may be processed, as appropriate, to obtain a final wrought product from the material. For instance, and referring now to FIGS. 3-4, steps (100)-(400) of FIG. 3, described above, may be considered a casting step (10), shown in FIG. 4, resulting in the above-described crack-free ingot. In other embodiments, the crack-free product may be a crack-free preform produced by, for instance, shape casting, additive manufacturing or powder metallurgy. In any event, the crack-free product may be further processed to obtain a wrought final product having the alpha-beta structure, optionally, with one or more of the precipitate phase(s) therein. This further processing may include any combination of dissolving (20) and working (30) steps, described below, as appropriate to achieve the final product form. Once the final product form is realized, the material may be precipitation hardened (40) to develop strengthening precipitates. The final product form may be a rolled product, an extruded product or a forged product, for instance.

With continued reference to FIG. 4, as a result of the casting step (10), the ingot may include some second phase particles. The method may therefore include one or more dissolving steps (20), where the ingot, an intermediate product form and/or the final product form are heated above the solvus temperature of the applicable precipitate(s) but below the solidus temperature of the material, thereby dissolving some of or all of the second phase particles. The dissolving step (20) may include soaking the material for a time sufficient to dissolve the applicable second phase particles. After the soak, the material may be cooled to ambient temperature for subsequent working. Alternatively, after the soak, the material may be immediately hot worked via the working step (30).

The working step (30) generally involves hot working and/or cold working the ingot and/or an intermediate product form. The hot working and/or cold working may include rolling, extrusion or forging of the material, for instance. The working (30) may occur before and/or after any dissolving step (20). For instance, after the conclusion of a dissolving step (20), the material may be allowed to cool to ambient temperature, and then reheated to an appropriate temperature for hot working. Alternatively, the material may be cold worked at around ambient temperatures. In some embodiments, the material may be hot worked, cooled to ambient, and then cold worked. In yet other embodiments, the hot working may commence after a soak of a dissolving step (20) so that reheating of the product is not required for hot working.

The working step (30) may result in precipitation of second phase particles. In this regard, any number of post-working dissolving steps (20) can be utilized, as appropriate, to dissolve some of or all of the second phase particles that may have formed due to the working step (30).

After any appropriate dissolving (20) and working (30) steps, the final product form may be precipitation hardened (40). The precipitation hardening (40) may include heating the final product form to above the applicable solvus temperature(s) for a time sufficient to dissolve at least some second phase particles precipitated due to the working, and then rapidly cooling the final product form to below the applicable solvus temperature(s) thereby forming precipitate particles, or rapidly cooling to ambient temperature, and then reheating the product to one or more temperatures below the applicable solvus temperature(s), thereby forming precipitate particles. The precipitation hardening (40) will further include holding the product at the target temperature for a time sufficient to form strengthening precipitates, and then cooling the product to ambient temperature, thereby realizing a final heat treated product having strengthening precipitates therein. In one embodiment, the final heat treated product contains ≧0.5 vol. % of the strengthening precipitates. The strengthening precipitates are preferably located within the matrix of the titanium alloy, thereby conferring strength to the product through interactions with dislocations.

Due to the structure and composition of the new materials, the new materials may realize an improved combination of properties, such as an improved combination of at least two of density, ductility, strength, fracture toughness, oxidation resistance, fatigue resistance, creep resistance, and elevated temperature resistance, among others. Thus, the new materials may find use in various applications, such as use in high temperature applications employed in the automotive and aerospace industries, to name a few. For instance, the new materials may find applicability as turbine components in high temperature applications. In one embodiment, the new material is employed in an application requiring operation at a temperature of from 400° C. to 1000° C., or higher. In one embodiment, the new material is employed in an application requiring operation at a temperature of from 600° C. to 1000° C., or higher. In one embodiment, the new material is employed in an application requiring operation at a temperature of from 400° C. to 800° C.

The new materials described above can also be used to produce shape cast products or preforms. Shape cast products are those products that achieve their final or near final product form after the casting process. The new materials may be shape cast into any desired shape. In one embodiment, the new materials are shape cast into an automotive or aerospace component (e.g., shape cast into an engine component). After casting, the shape cast product may be subject to any appropriate dissolving (20) or precipitation hardening (40) steps, as described above. In one embodiment, a shape cast product consists essentially of the Ti, the Al, and the Mo, and within the scope of the compositions described above. In one embodiment, the shape cast product includes ≧0.5 vol. % of strengthening precipitates.

While this patent application has generally been described as relating to alpha-beta titanium alloy materials optionally having one or more of the above enumerated precipitate phase(s) therein, it is to be appreciated that other hardening phases may be applicable to the new alloy materials, and all such hardening phases (coherent or incoherent) may find utility in the titanium alloy materials described herein.

### Additive Manufacturing of New Materials

It is also possible to manufacture the new materials described above by additive manufacturing. As used herein, “additive manufacturing” means, “a process of joining materials to make objects from 3D model data, usually layer upon layer, as opposed to subtractive manufacturing methodologies”, as defined in ASTM F2792-12a entitled “Standard Terminology for Additively Manufacturing Technologies”. The new materials may be manufactured via any appropriate additive manufacturing technique described in this ASTM standard, such as binder jetting, directed energy deposition, material extrusion, material jetting, powder bed fusion, or sheet lamination, among others.

In one embodiment, an additive manufacturing process includes depositing successive layers of one or more powders and then selectively melting and/or sintering the powders to create, layer-by-layer, an additively manufactured body (product). In one embodiment, an additive manufacturing processes uses one or more of Selective Laser Sintering (SLS), Selective Laser Melting (SLM), and Electron Beam Melting (EBM), among others. In one embodiment, an additive manufacturing process uses an EOSINT M 280 Direct Metal Laser Sintering (DMLS) additive manufacturing system, or comparable system, available from EOS GmbH (Robert-Stirling-Ring 1, 82152 Krailling/Munich, Germany).

As one example, a feedstock, such as a powder or wire, comprising (or consisting essentially of) the alloying elements and any optional incidental elements, and within the scope of the compositions described above, may be used in an additive manufacturing apparatus to produce an additively manufactured body comprising an alpha-beta structure, optionally with precipitate phase(s) therein. In some embodiments, the additively manufactured body is a crack-free preform. The powders may be selectively heated above the liquidus temperature of the material, thereby forming a molten pool having the alloying elements and any optional incidental elements, followed by rapid solidification of the molten pool.

As noted above, additive manufacturing may be used to create, layer-by-layer, a metal product (e.g., an alloy product), such as via a metal powder bed. In one embodiment, a metal powder bed is used to create a product (e.g., a tailored alloy product). As used herein a “metal powder bed” and the like means a bed comprising a metal powder. During additive manufacturing, particles of the same or different compositions may melt (e.g., rapidly melt) and then solidify (e.g., in the absence of homogenous mixing). Thus, products having a homogenous or non-homogeneous microstructure may be produced. One embodiment of a method of making an additively manufactured body may include (a) dispersing a powder comprising the alloying elements and any optional incidental elements, (b) selectively heating a portion of the powder (e.g., via a laser) to a temperature above the liquidus temperature of the particular body to be formed, (c) forming a molten pool having the alloying elements and any optional incidental elements, and (d) cooling the molten pool at a cooling rate of at least 1000° C. per second. In one embodiment, the cooling rate is at least 10,000° C. per second. In another embodiment, the cooling rate is at least 100,000° C. per second. In another embodiment, the cooling rate is at least 1,000,000° C. per second. Steps (a)-(d) may be repeated as necessary until the body is completed, i.e., until the final additively manufactured body is formed/completed. The final additively manufactured body comprising the alpha-beta structure, optionally with the precipitate phase(s) therein, may be of a complex geometry, or may be of a simple geometry (e.g., in the form of a sheet or plate). After or during production, an additively manufactured product may be deformed (e.g., by one or more of rolling, extruding, forging, stretching, compressing).

The powders used to additively manufacture a new material may be produced by atomizing a material (e.g., an ingot or melt) of the new material into powders of the appropriate dimensions relative to the additive manufacturing process to be used. As used herein, “powder” means a material comprising a plurality of particles. Powders may be used in a powder bed to produce a tailored alloy product via additive manufacturing. In one embodiment, the same general powder is used throughout the additive manufacturing process to produce a metal product. For instance, the final tailored metal product may comprise a single region/matrix produced by using generally the same metal powder during the additive manufacturing process. The final tailored metal product may alternatively comprise at least two separately produced distinct regions. In one embodiment, different metal powder bed types may be used to produce a metal product. For instance, a first metal powder bed may comprise a first metal powder and a second metal powder bed may comprise a second metal powder, different than the first metal powder. The first metal powder bed may be used to produce a first layer or portion of the alloy product, and the second metal powder bed may be used to produce a second layer or portion of the alloy product. As used herein, a “particle” means a minute fragment of matter having a size suitable for use in the powder of the powder bed (e.g., a size of from 5 microns to 100 microns). Particles may be produced, for example, via atomization.

The additively manufactured body may be subject to any appropriate dissolving (20), working (30) and/or precipitation hardening steps (40), as described above. If employed, the dissolving (20) and/or the working (30) steps may be conducted on an intermediate form of the additively manufactured body and/or may be conducted on a final form of the additively manufactured body. If employed, the precipitation hardening step (40) is generally conducted relative to the final form of the additively manufactured body. In one embodiment, an additively manufactured body consists essentially of the alloying elements and any incidental elements and impurities, such as any of the material compositions described above, optionally with ≧0.5 vol. % of precipitate phase(s) therein.

In another embodiment, the new material is a preform for subsequent working. A preform may be an ingot, a shape casting, an additively manufactured product, or a powder metallurgy product. In one embodiment, a preform is of a shape that is close to the final desired shape of the final product, but the preform is designed to allow for subsequent working to achieve the final product shape. Thus, the preform may be worked (30) such as by forging, rolling, or extrusion to produce an intermediate product or a final product, which intermediate or final product may be subject to any further appropriate dissolving (20), working (30) and/or precipitation hardening steps (40), as described above, to achieve the final product. In one embodiment, the working comprises hot isostatic pressing (hipping) to compress the part. In one embodiment, an alloy preform may be compressed and porosity may be reduced. In one embodiment, the hipping temperature is maintained below the incipient melting point of the alloy preform. In one embodiment, the preform may be a near net shape product.

In one approach, electron beam (EB) or plasma arc techniques are utilized to produce at least a portion of the additively manufactured body. Electron beam techniques may facilitate production of larger parts than readily produced via laser additive manufacturing techniques. In one embodiment, a method comprises feeding a small diameter wire (e.g., ≦2.54 mm in diameter) to the wire feeder portion of an electron beam gun. The wire may be of the compositions, described above. The electron beam (EB) heats the wire above the liquidus point of the body to be formed, followed by rapid solidification (e.g., at least 100° C. per second) of the molten pool to form the deposited material. The wire could be fabricated by a conventional ingot process or by a powder consolidation process. These steps may be repeated as necessary until the final product is produced. Plasma arc wire feed may similarly be used with the alloys disclosed herein. In one embodiment, not illustrated, an electron beam (EB) or plasma arc additive manufacturing apparatus may employ multiple different wires with corresponding multiple different radiation sources, each of the wires and sources being fed and activated, as appropriate to provide the product having a metal matrix having the alloying elements and any optional incidental elements.

In another approach, a method may comprise (a) selectively spraying one or more metal powders towards or on a building substrate, (b) heating, via a radiation source, the metal powders, and optionally the building substrate, above the liquidus temperature of the product to be formed, thereby forming a molten pool, (c) cooling the molten pool, thereby forming a solid portion of the metal product, wherein the cooling comprises cooling at a cooling rate of at least 100° C. per second. In one embodiment, the cooling rate is at least 1000° C. per second. In another embodiment, the cooling rate is at least 10,000° C. per second. The cooling step (c) may be accomplished by moving the radiation source away from the molten pool and/or by moving the building substrate having the molten pool away from the radiation source. Steps (a)-(c) may be repeated as necessary until the metal product is completed. The spraying step (a) may be accomplished via one or more nozzles, and the composition of the metal powders can be varied, as appropriate, to provide tailored final metal products having a metal matrix, the metal matrix having the alloying elements and any optional incidental elements. The composition of the metal powder being heated at any one time can be varied in real-time by using different powders in different nozzles and/or by varying the powder composition(s) provided to any one nozzle in real-time. The work piece can be any suitable substrate. In one embodiment, the building substrate is, itself, a metal product (e.g., an alloy product.)

As noted above, welding may be used to produce metal products (e.g., to produce alloy products). In one embodiment, the product is produced by a melting operation applied to pre-cursor materials in the form of a plurality of metal components of different composition. The pre-cursor materials may be presented in juxtaposition relative to one another to allow simultaneous melting and mixing. In one example, the melting occurs in the course of electric arc welding. In another example, the melting may be conducted by a laser or an electron beam during additive manufacturing. The melting operation results in the plurality of metal components mixing in a molten state and forming the metal product, such as in the form of an alloy. The pre-cursor materials may be provided in the form of a plurality of physically separate forms, such as a plurality of elongated strands or fibers of metals or metal alloys of different composition or an elongated strand or a tube of a first composition and an adjacent powder of a second composition, e.g., contained within the tube or a strand having one or more clad layers. The pre-cursor materials may be formed into a structure, e.g., a twisted or braided cable or wire having multiple strands or fibers or a tube with an outer shell and a powder contained in the lumen thereof. The structure may then be handled to subject a portion thereof, e.g., a tip, to the melting operation, e.g., by using it as a welding electrode or as a feed stock for additive manufacturing. When so used, the structure and its component pre-cursor materials may be melted, e.g., in a continuous or discrete process to form a weld bead or a line or dots of material deposited for additive manufacture.

In one embodiment, the metal product is a weld body or filler interposed between and joined to a material or material to the weld, e.g., two bodies of the same or different material or a body of a single material with an aperture that the filler at least partially fills. In another embodiment, the filler exhibits a transition zone of changing composition relative to the material to which it is welded, such that the resultant combination could be considered the alloy product.

### New Materials Consisting Essentially of an Alpha-Beta Solid Solution Structure

While the above disclosure generally describes how to produce new alpha-beta titanium alloy materials having precipitate phase(s) therein, it is also possible to produce a material consisting essentially of an alpha-beta structure. For instance, after production of an ingot, a wrought body, a shape casting, or an additively manufactured body, as described above, the material may be homogenized, such as in a manner described relative to the dissolving step (20), above. With appropriate rapid cooling, precipitation of any second phase particles may be inhibited/restricted, thereby realizing an alpha-beta material essentially free of any second phase particles.

### Alloy Properties

The new materials may realize an improved combination of properties. In this section all mechanical properties are measured in the longitudinal (L) direction, unless otherwise specified. In this section “heat treated” means solution heat treated, then water quenched, and then heat treated at 565° C. for 6 hours, and then air cooled.

In one approach, a new material may realize an as-cast tensile yield strength (TYS) of at least 715 MPa when tested in accordance with ASTM E8 at room temperature (RT). In one embodiment, a new material may realize an as-cast, RT TYS of at least 725 MPa. In another embodiment, a new material may realize an as-cast, RT TYS of at least 735 MPa. In yet another embodiment, a new material may realize an as-cast, RT TYS of at least 745 MPa. In another embodiment, a new material may realize an as-cast, RT TYS of at least 755 MPa. In yet another embodiment, a new material may realize an as-cast, RT TYS of at least 765 MPa. In another embodiment, a new material may realize an as-cast, RT TYS of at least 775 MPa. In yet another embodiment, a new material may realize an as-cast, RT TYS of at least 785 MPa. In another embodiment, a new material may realize an as-cast, RT TYS of at least 792 MPa. In any of these embodiments, a new material may realize an as-cast, RT elongation of at least 1.0%. In any of these embodiments, a new material may realize an as-cast, RT elongation of at least 2.0%. In any of these embodiments, a new material may realize an as-cast, RT elongation of at least 3.0%. In any of these embodiments, a new material may realize an as-cast, RT elongation of at least 4.0%. In any of these embodiments, a new material may realize an as-cast, RT elongation of at least 5.0%. In any of these embodiments, a new material may realize an as-cast, RT elongation of at least 6.0%. In any of these embodiments, a new material may realize an as-cast, RT elongation of at least 7.0%. In any of these embodiments, a new material may realize an as-cast, RT elongation of at least 8.0%.

In one approach, a new material may realize an as-cast ultimate tensile strength (UTS) of at least 880 MPa when tested in accordance with ASTM E8 at room temperature. In one embodiment, a new material may realize an as-cast, RT UTS of at least 890 MPa. In another embodiment, a new material may realize an as-cast, RT UTS of at least 900 MPa. In yet another embodiment, a new material may realize an as-cast, RT UTS of at least 910 MPa. In another embodiment, a new material may realize an as-cast, RT UTS of at least 920 MPa. In yet another embodiment, a new material may realize an as-cast, RT UTS of at least 930 MPa. In another embodiment, a new material may realize an as-cast, RT UTS of at least 940 MPa. In yet another embodiment, a new material may realize an as-cast, RT UTS of at least 950 MPa. In another embodiment, a new material may realize an as-cast, RT UTS of at least 953 MPa. In any of these embodiments, a new material may realize an as-cast, RT elongation of at least 1.0%. In any of these embodiments, a new material may realize an as-cast, RT elongation of at least 2.0%. In any of these embodiments, a new material may realize an as-cast, RT elongation of at least 3.0%. In any of these embodiments, a new material may realize an as-cast, RT elongation of at least 4.0%. In any of these embodiments, a new material may realize an as-cast, RT elongation of at least 5.0%. In any of these embodiments, a new material may realize an as-cast, RT elongation of at least 6.0%. In any of these embodiments, a new material may realize an as-cast, RT elongation of at least 7.0%. In any of these embodiments, a new material may realize an as-cast, RT elongation of at least 8.0%.

In one approach, a new material may realize an as-cast TYS of at least 230 MPa when tested in accordance with ASTM E21 at 650° C. In one embodiment, a new material may realize an as-cast TYS of at least 250 MPa at 650° C. In another embodiment, a new material may realize an as-cast TYS of at least 270 MPa at 650° C. In yet another embodiment, a new material may realize an as-cast TYS of at least 290 MPa at 650° C. In another embodiment, a new material may realize an as-cast TYS of at least 310 MPa at 650° C. In yet another embodiment, a new material may realize an as-cast TYS of at least 330 MPa at 650° C. In another embodiment, a new material may realize an as-cast TYS of at least 350 MPa at 650° C. In yet another embodiment, a new material may realize an as-cast TYS of at least 370 MPa at 650° C. In another embodiment, a new material may realize an as-cast TYS of at least 390 MPa at 650° C. In any of these embodiments, a new material may realize an as-cast elongation of at least 2.0% at 650° C. In any of these embodiments, a new material may realize an as-cast elongation of at least 4.0% at 650° C. In any of these embodiments, a new material may realize an as-cast elongation of at least 6.0% at 650° C. In any of these embodiments, a new material may realize an as-cast elongation of at least 8.0% at 650° C. In any of these embodiments, a new material may realize an as-cast elongation of at least 10.0% at 650° C. In any of these embodiments, a new material may realize an as-cast elongation of at least 12.0% at 650° C. In any of these embodiments, a new material may realize an as-cast elongation of at least 14.0% at 650° C. In any of these embodiments, a new material may realize an as-cast elongation of at least 16.0% at 650° C. In any of these embodiments, a new material may realize an as-cast elongation of at least 17.0% at 650° C. In any of these embodiments, a new material may realize an as-cast elongation of at least 18.0% at 650° C.

In one approach, a new material may realize an as-cast UTS of at least 365 MPa when tested in accordance with ASTM E21 at 650° C. In one embodiment, a new material may realize an as-cast UTS of at least 385 MPa at 650° C. In another embodiment, a new material may realize an as-cast UTS of at least 405 MPa at 650° C. In yet another embodiment, a new material may realize an as-cast UTS of at least 425 MPa at 650° C. In another embodiment, a new material may realize an as-cast UTS of at least 445 MPa at 650° C. In yet another embodiment, a new material may realize an as-cast UTS of at least 465 MPa at 650° C. In another embodiment, a new material may realize an as-cast UTS of at least 485 MPa at 650° C. In yet another embodiment, a new material may realize an as-cast UTS of at least 505 MPa at 650° C. In another embodiment, a new material may realize an as-cast UTS of at least 525 MPa at 650° C. In any of these embodiments, a new material may realize an as-cast elongation of at least 2.0% at 650° C. In any of these embodiments, a new material may realize an as-cast elongation of at least 4.0% at 650° C. In any of these embodiments, a new material may realize an as-cast elongation of at least 6.0% at 650° C. In any of these embodiments, a new material may realize an as-cast elongation of at least 8.0% at 650° C. In any of these embodiments, a new material may realize an as-cast elongation of at least 10.0% at 650° C. In any of these embodiments, a new material may realize an as-cast elongation of at least 12.0% at 650° C. In any of these embodiments, a new material may realize an as-cast elongation of at least 14.0% at 650° C. In any of these embodiments, a new material may realize an as-cast elongation of at least 16.0% at 650° C. In any of these embodiments, a new material may realize an as-cast elongation of at least 17.0% at 650° C. In any of these embodiments, a new material may realize an as-cast elongation of at least 18.0% at 650° C.

In one approach, a new material may realize a TYS of at least 800 MPa in the heat treated condition, when tested in accordance with ASTM E8 at room temperature. In one embodiment, a new material may realize a heat treated, RT TYS of at least 825 MPa. In another embodiment, a new material may realize a heat treated, RT TYS of at least 840 MPa. In yet another embodiment, a new material may realize a heat treated, RT TYS of at least 865 MPa. In another embodiment, a new material may realize a heat treated, RT TYS of at least 890 MPa. In yet another embodiment, a new material may realize a heat treated, RT TYS of at least 900 MPa. In any of these embodiments, a new material may realize a heat treated, RT elongation of at least 2.0%. In any of these embodiments, a new material may realize a heat treated, RT elongation of at least 3.0%. In any of these embodiments, a new material may realize a heat treated, RT elongation of at least 4.0%. In any of these embodiments, a new material may realize a heat treated, RT elongation of at least 5.0%. In any of these embodiments, a new material may realize a heat treated, RT elongation of at least 6.0%. In any of these embodiments, a new material may realize a heat treated, RT elongation of at least 7.0%. In any of these embodiments, a new material may realize a heat treated, RT elongation of at least 8.0%.

In one approach, a new material may realize a UTS of at least 900 MPa in the heat treated condition, when tested in accordance with ASTM E8 at room temperature. In one embodiment, a new material may realize a heat treated, RT UTS of at least 920 MPa. In another embodiment, a new material may realize a heat treated, RT UTS of at least 940 MPa. In yet another embodiment, a new material may realize a heat treated, RT UTS of at least 960 MPa. In another embodiment, a new material may realize a heat treated, RT UTS of at least 980 MPa. In yet another embodiment, a new material may realize a heat treated, RT UTS of at least 1000 MPa. In another embodiment, a new material may realize a heat treated, RT UTS of at least 1010 MPa. In any of these embodiments, a new material may realize a heat treated, RT elongation of at least 2.0%. In any of these embodiments, a new material may realize a heat treated, RT elongation of at least 3.0%. In any of these embodiments, a new material may realize a heat treated, RT elongation of at least 4.0%. In any of these embodiments, a new material may realize a heat treated, RT elongation of at least 5.0%. In any of these embodiments, a new material may realize a heat treated, RT elongation of at least 6.0%. In any of these embodiments, a new material may realize a heat treated, RT elongation of at least 7.0%. In any of these embodiments, a new material may realize a heat treated, RT elongation of at least 8.0%.

In one approach, a new material may realize a TYS of at least 300 MPa in the heat treated condition, when tested in accordance with ASTM E21 at 650° C. In on embodiment, a new material may realize a heat treated TYS of at least 325 MPa 650° C. In another embodiment, a new material may realize a heat treated TYS of at least 350 MPa at 650° C. In yet another embodiment, a new material may realize a heat treated TYS of at least 375 MPa at 650° C. In another embodiment, a new material may realize a heat treated TYS of at least 400 MPa at 650° C. In yet another embodiment, a new material may realize a heat treated TYS of at least 410 MPa at 650° C. In another embodiment, a new material may realize a heat treated TYS of at least 425 MPa at 650° C. In yet another embodiment, a new material may realize a heat treated TYS of at least 435 MPa at 650° C. In any of these embodiments, a new material may realize a heat treated elongation of at least 2.0% at 650° C. In any of these embodiments, a new material may realize a heat treated elongation of at least 4.0% at 650° C. In any of these embodiments, a new material may realize a heat treated elongation of at least 6.0% at 650° C. In any of these embodiments, a new material may realize a heat treated elongation of at least 8.0% at 650° C. In any of these embodiments, a new material may realize a heat treated elongation of at least 10.0% at 650° C. In any of these embodiments, a new material may realize a heat treated elongation of at least 12.0% at 650° C. In any of these embodiments, a new material may realize a heat treated elongation of at least 14.0% at 650° C. In any of these embodiments, a new material may realize a heat treated elongation of at least 16.0% at 650° C. In any of these embodiments, a new material may realize a heat treated elongation of at least 17.0% at 650° C. In any of these embodiments, a new material may realize a heat treated elongation of at least 18.0% at 650° C.

In one approach, a new material may realize a UTS of at least 400 MPa in the heat treated condition, when tested in accordance with ASTM E21 at 650° C. In one embodiment, a new material may realize a heat treated UTS of at least 425 MPa at 650° C. In another embodiment, a new material may realize a heat treated UTS of at least 450 MPa at 650° C. In yet another embodiment, a new material may realize a heat treated UTS of at least 475 MPa at 650° C. In another embodiment, a new material may realize a heat treated UTS of at least 500 MPa at 650° C. In yet another embodiment, a new material may realize a heat treated UTS of at least 525 MPa at 650° C. In another embodiment, a new material may realize a heat treated UTS of at least 545 MPa at 650° C. In any of these embodiments, a new material may realize a heat treated elongation of at least 2.0% at 650° C. In any of these embodiments, a new material may realize a heat treated elongation of at least 4.0% at 650° C. In any of these embodiments, a new material may realize a heat treated elongation of at least 6.0% at 650° C. In any of these embodiments, a new material may realize a heat treated elongation of at least 8.0% at 650° C. In any of these embodiments, a new material may realize a heat treated elongation of at least 10.0% at 650° C. In any of these embodiments, a new material may realize a heat treated elongation of at least 12.0% at 650° C. In any of these embodiments, a new material may realize a heat treated elongation of at least 14.0% at 650° C. In any of these embodiments, a new material may realize a heat treated elongation of at least 16.0% at 650° C. In any of these embodiments, a new material may realize a heat treated elongation of at least 17.0% at 650° C. In any of these embodiments, a new material may realize a heat treated elongation of at least 18.0% at 650° C.

In one approach, the new materials may realize improved properties over a Ti-6Al-4V alloy of the same product form and heat treated condition when tested in accordance with ASTM E8 at room temperature. In one embodiment, the new materials may realize at least 3.0% higher RT TYS as compared to a Ti-6Al-4V product of the same product form and heat treatment. In one embodiment, the new materials may realize at least 5.0% higher RT TYS as compared to a Ti-6Al-4V product of the same product form and heat treatment. In one embodiment, the new materials may realize at least 7.0% higher RT TYS as compared to a Ti-6Al-4V product of the same product form and heat treatment. In one embodiment, the new materials may realize at least 9.0% higher RT TYS as compared to a Ti-6Al-4V product of the same product form and heat treatment. In one embodiment, the new materials may realize at least 11.0% higher RT TYS as compared to a Ti-6Al-4V product of the same product form and heat treatment. In one embodiment, the new materials may realize at least 12.0% higher RT TYS as compared to a Ti-6Al-4V product of the same product form and heat treatment. In any of these embodiments, the new materials may realize the higher RT TYS at equivalent elongation.

In one embodiment, the new materials may realize at least 2.0% higher RT UTS as compared to a Ti-6Al-4V product of the same product form and heat treatment. In one embodiment, the new materials may realize at least 4.0% higher RT UTS as compared to a Ti-6Al-4V product of the same product form and heat treatment. In one embodiment, the new materials may realize at least 6.0% higher RT UTS as compared to a Ti-6Al-4V product of the same product form and heat treatment. In one embodiment, the new materials may realize at least 7.0% higher RT UTS as compared to a Ti-6Al-4V product of the same product form and heat treatment. In one embodiment, the new materials may realize at least 8.0% higher RT UTS as compared to a Ti-6Al-4V product of the same product form and heat treatment. In one embodiment, the new materials may realize at least 9.0% higher RT UTS as compared to a Ti-6Al-4V product of the same product form and heat treatment. In any of these embodiments, the new materials may realize the higher UTS at equivalent elongation.

In one embodiment, the new materials may realize at least 10% higher TYS as compared to a Ti-6Al-4V product of the same product form and heat treated condition when tested at 650° C. in accordance with ASTM E21. In one embodiment, the new materials may realize at least 20% higher TYS as compared to a Ti-6Al-4V product of the same product form and heat treated condition at 650° C. In one embodiment, the new materials may realize at least 30% higher TYS as compared to a Ti-6Al-4V product of the same product form and heat treated condition at 650° C. In one embodiment, the new materials may realize at least 40% higher TYS as compared to a Ti-6Al-4V product of the same product form and heat treated condition at 650° C. In one embodiment, the new materials may realize at least 50% higher TYS as compared to a Ti-6Al-4V product of the same product form and heat treated condition at 650° C. In one embodiment, the new materials may realize at least 60% higher TYS as compared to a Ti-6Al-4V product of the same product form and heat treated condition at 650° C. In one embodiment, the new materials may realize at least 70% higher TYS as compared to a Ti-6Al-4V product of the same product form and heat treated condition at 650° C. In one embodiment, the new materials may realize at least 75% higher TYS as compared to a Ti-6Al-4V product of the same product form and heat treated condition at 650° C. In any of these embodiments, the new materials may realize the higher TYS at equivalent elongation.

In one embodiment, the new materials may realize at least 5% higher UTS as compared to a Ti-6Al-4V product of the same product form and heat treated condition at 650° C. In one embodiment, the new materials may realize at least 10% higher UTS as compared to a Ti-6Al-4V product of the same product form and heat treated condition at 650° C. In one embodiment, the new materials may realize at least 15% higher UTS as compared to a Ti-6Al-4V product of the same product form and heat treated condition at 650° C. In one embodiment, the new materials may realize at least 20% higher UTS as compared to a Ti-6Al-4V product of the same product form and heat treated condition at 650° C. In one embodiment, the new materials may realize at least 25% higher UTS as compared to a Ti-6Al-4V product of the same product form and heat treated condition at 650° C. In one embodiment, the new materials may realize at least 30% higher UTS as compared to a Ti-6Al-4V product of the same product form and heat treated condition at 650° C. In one embodiment, the new materials may realize at least 35% higher UTS as compared to a Ti-6Al-4V product of the same product form and heat treated condition at 650° C. In one embodiment, the new materials may realize at least 40% higher UTS as compared to a Ti-6Al-4V product of the same product form and heat treated condition at 650° C. In one embodiment, the new materials may realize at least 45% higher UTS as compared to a Ti-6Al-4V product of the same product form and heat treated condition at 650° In one embodiment, the new materials may realize at least 50% higher UTS as compared to a Ti-6Al-4V product of the same product form and heat treated condition at 650° C. In any of these embodiments, the new materials may realize the higher UTS at equivalent elongation.

### BRIEF DESCRIPTION OF THE DRAWINGS

FIG. 1 is a schematic illustration of bcc, fcc, and hcp unit cells.

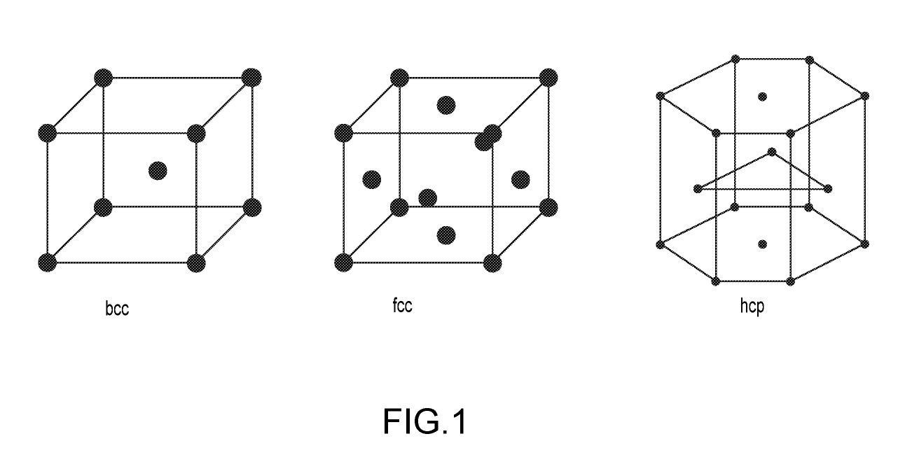

FIG. 2a is a graph of the solidification path of a Ti-8Al-2Mo alloy and a prior art Ti-7Al-4Mo alloy based on the Scheil model.

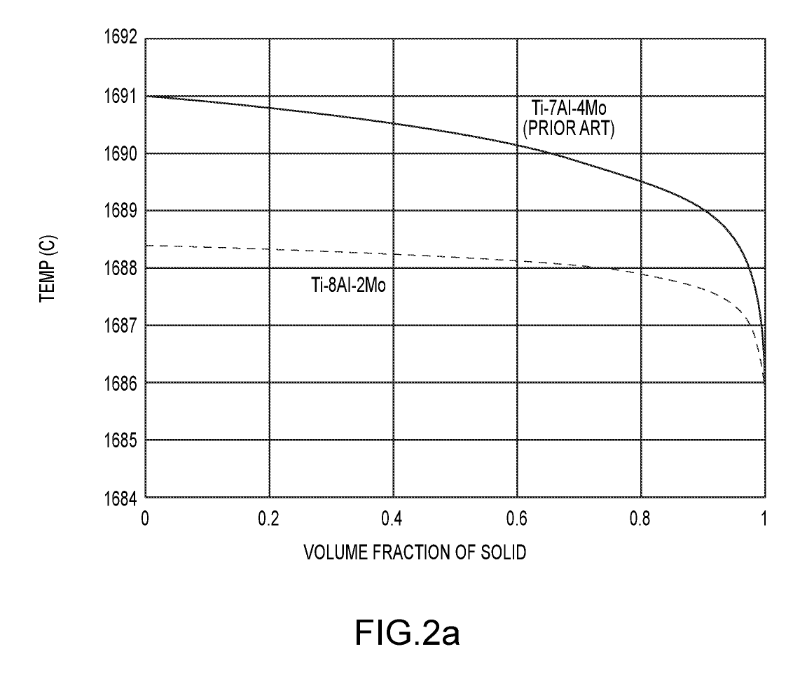

FIG. 2b is a graph of the effect of aluminum content on the equilibrium freezing range of a Ti-2Mo-XAl alloy.

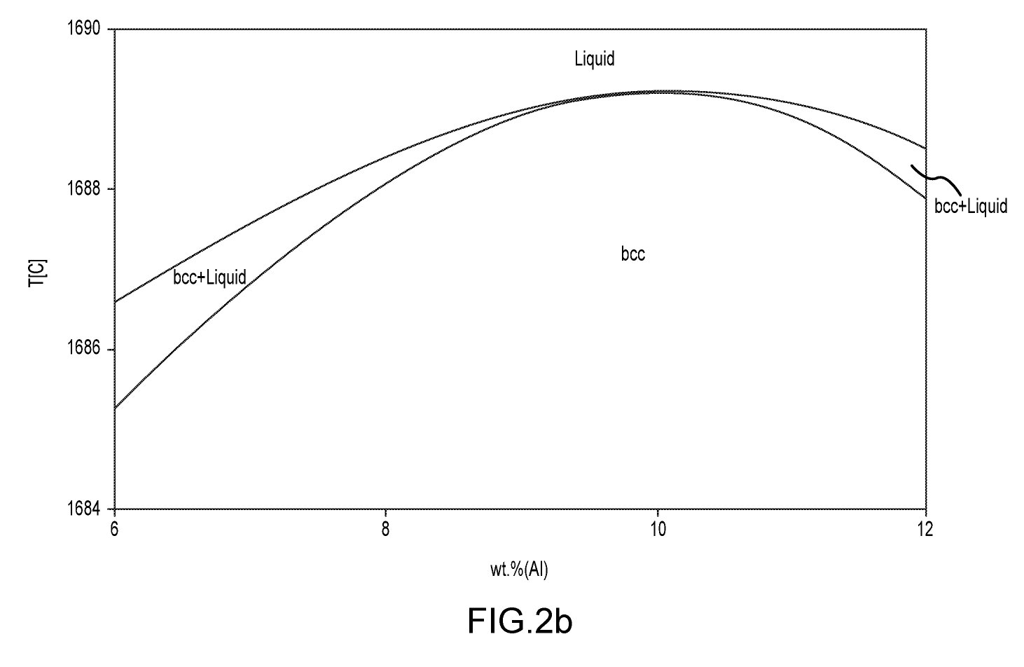

FIG. 2c is graph of the effect of aluminum content on the equilibrium phase fields of a Ti-2Mo-XAl alloy in the solid state.

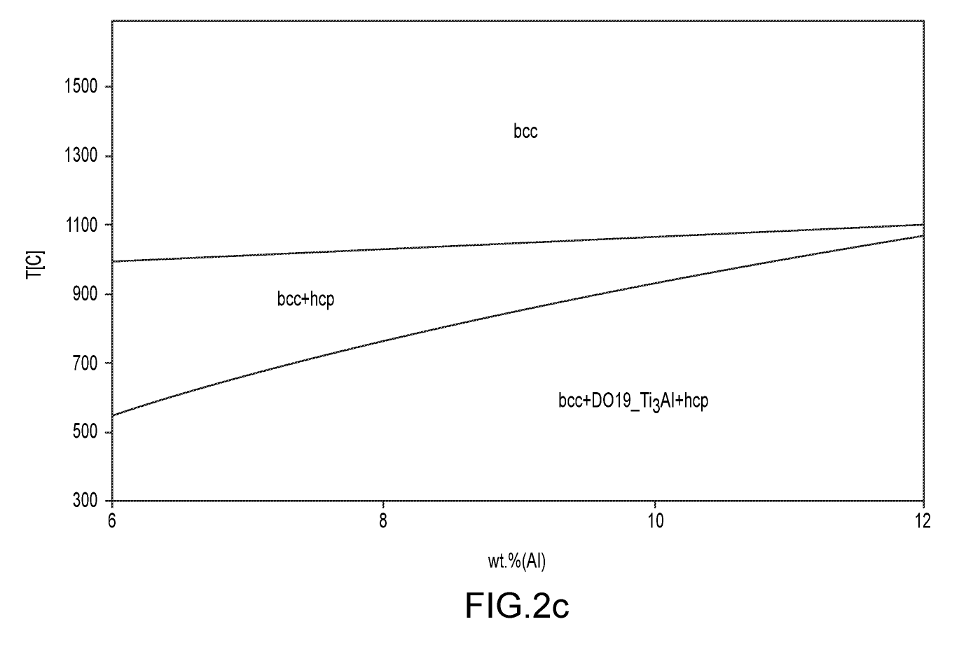

FIG. 2d is a graph of the effect of molybdenum content on the equilibrium freezing range of a Ti-8Al-XMo alloy.

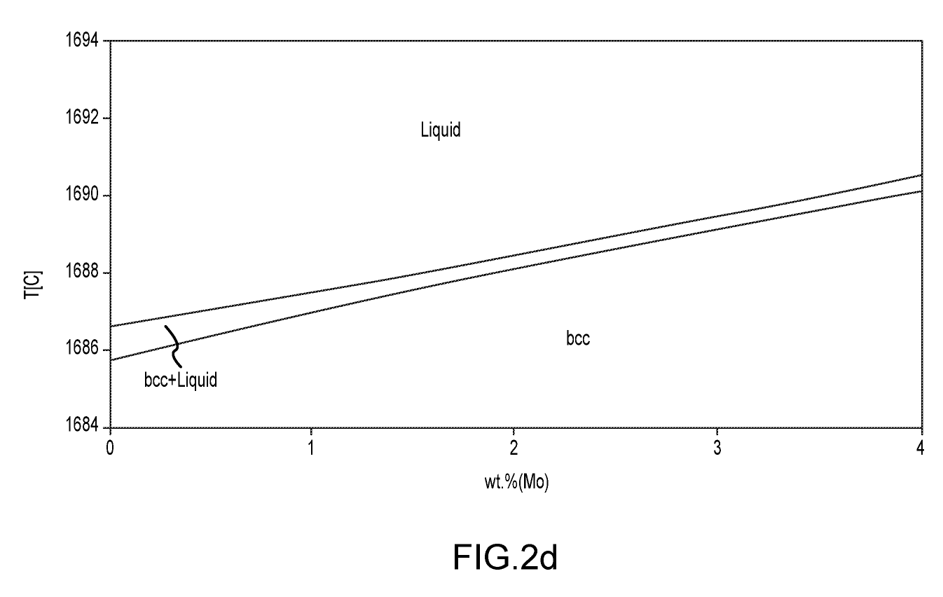

FIG. 2e is a graph of the effect of molybdenum on the equilibrium phase fields of a Ti-8Al-XMo alloy in the solid state.

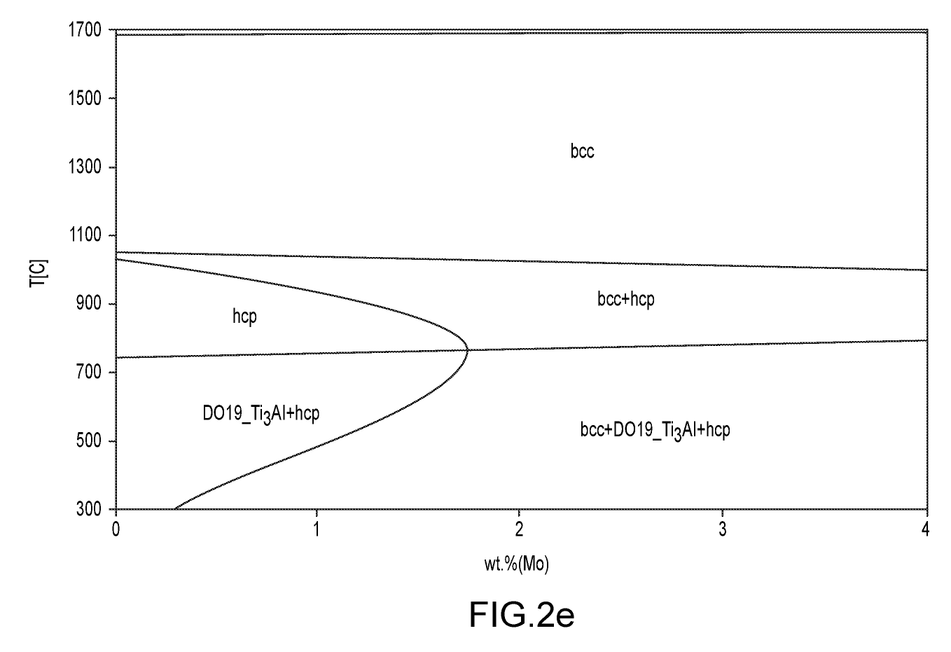

FIG. 3 is a flow chart of one embodiment of a method to produce a new material.

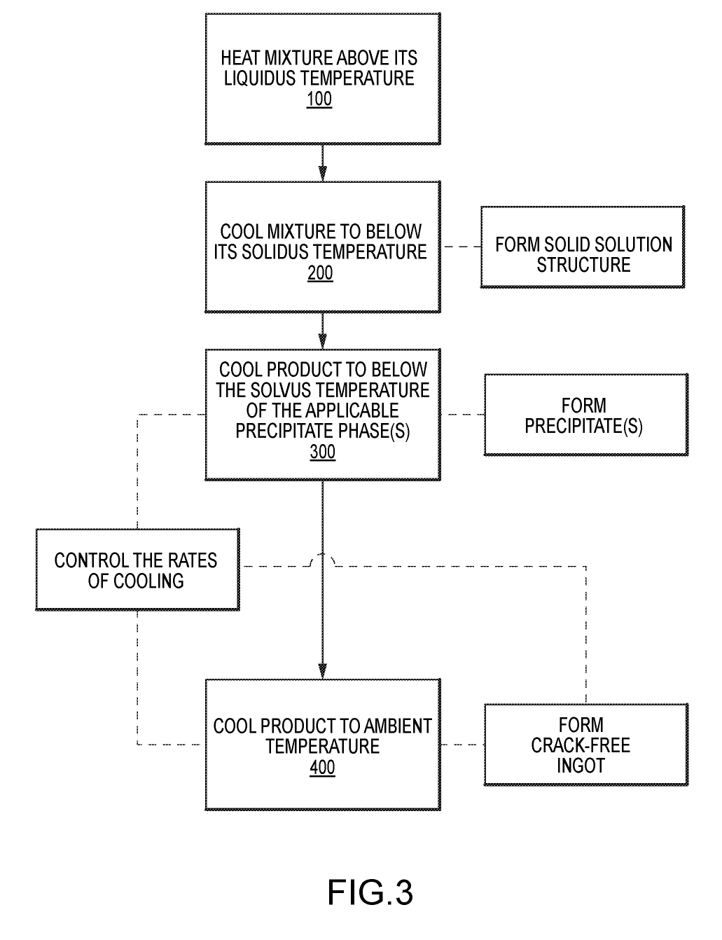

FIG. 4 is a flow chart of one embodiment of a method to obtain a wrought product having an-alpha beta solid solution structure with one of more of the precipitates therein.

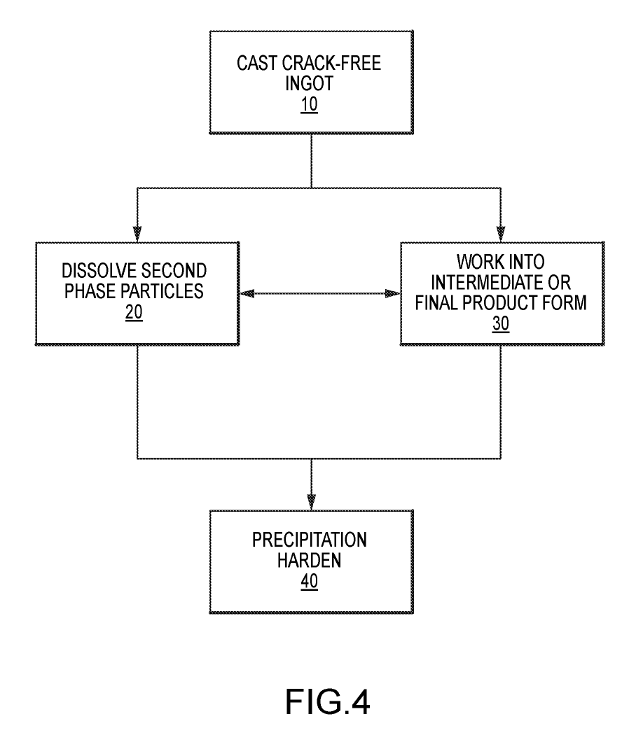

### DETAILED DESCRIPTION

### Example 1: Testing of Ti—Al-2Mo and Conventional Ti-6Al-4V Alloys

A Ti-8Al-2Mo (7.7 wt. % Al and 1.8 wt. % Mo, the balance being Ti) and a conventional Ti-6Al-4V alloy were cast via arc melt casting into rods. After casting, mechanical properties of the as-cast alloys were measured in accordance with ASTM E8, the results of which are shown in Tables 3-4. Specimens of the Ti-8Al-2Mo alloy were solution heat treated at 940° C. for 1 hour, then water quenched, then heat treated at 565° C. for 6 hours, and then air cooled. The mechanical properties of the heat treated alloys were then tested, the results of which are shown in Table 4, below. All reported strength and elongation properties were from testing in the longitudinal (L) direction. Estimated toughness from the stress-strain curve produced during the mechanical property testing is shown below. Tensile properties at 650° C. were also tested in accordance with ASTM E21, and are also provided in the tables below.

TABLE 3
Ti—6Al—4V Properties

| Condition | TYS (MPa) | UTS (MPa) | Elong. (%) |
|---|---|---|---|
| As-Cast | 715 | 881 | 11 |
| As-Cast, | 229 | 366 | 16 |
| Elevated Temp. | | | |

TABLE 4
Ti—8Al—2Mo Properties

| Condition | TYS (MPa) | UTS (MPa) | Elong. (%) |
|---|---|---|---|
| As-Cast | 792 | 953 | 7 |
| Heat Treated | 902 | 1006 | 6 |
| As-Cast, | 390 | 526 | 16 |
| Elevated Temp. | | | |
| Heat Treated, | 434 | 545 | 16 |
| Elevated Temp. | | | |

While various embodiments of the new technology described herein have been described in detail, it is apparent that modifications and adaptations of those embodiments will occur to those skilled in the art. However, it is to be expressly understood that such modifications and adaptations are within the spirit and scope of the presently disclosed technology.

1. A titanium alloy comprising:
7.0-11.0 wt. % Al;
1.0-4.0 wt. % Mo;
wherein Al:Mo, by weight, is from 2.0:1-11.0:1;
the balance being Ti, optional incidental elements, and unavoidable impurities.

2. The titanium alloy of claim 1, wherein the alloy includes not greater than 10.5 wt. % Al.

3. The titanium alloy of claim 1, wherein the alloy includes not greater than 10.0 wt. % Al.

4. The titanium alloy of claim 1, wherein the alloy includes not greater than 9.5 wt. % Al.

5. The titanium alloy of claim 1, wherein the alloy includes not greater than 9.0 wt. % Al.

6. The titanium alloy of claim 1, wherein the alloy includes at least 1.5 wt. % Mo.

7. The titanium alloy of claim 6, wherein the alloy includes not greater than 3.5 wt. % Mo.

8. The titanium alloy claim 6, wherein the alloy includes not greater than 3.0 wt. % Mo.

9. The titanium alloy of claim 6, wherein the alloy includes not greater than 2.5 wt. % Mo.

10. The titanium alloy of claim 7, wherein the Al:Mo, by weight, is at least 2.33:1.

11. The titanium alloy of claim 10, wherein the Al:Mo, by weight, is not greater than 10.0:1.

12. The titanium alloy of claim 10, wherein the Al:Mo, by weight, is not greater than 6.33:1.

13. The titanium alloy of claim 1, wherein the titanium alloy is a titanium alloy body.

14. The titanium alloy body of claim 13, wherein the titanium alloy body is one of an ingot, a rolled product, an extrusion, a forging, a shape casting, or an additively manufactured product.

15. The titanium alloy body of claim 13, wherein the titanium alloy body is an automotive or aerospace component.

16. The titanium alloy body of claim 15, wherein the titanium alloy body is a turbine or engine component.

17. A method comprising:
(i) using a feedstock in an additive manufacturing apparatus, wherein the feedstock comprises:
7.0-11.0 wt. % Al;
1.0-4.0 wt. % Mo;
wherein Al:Mo, by weight, is from 2.0:1-11.0:1;
the balance being Ti, optional incidental elements, and unavoidable impurities
(ii) producing a metal product in the additive manufacturing apparatus using the feedstock.

18. The method of claim 17, wherein the feedstock comprises a powder feedstock, wherein the method comprises:
(a) dispersing a metal powder of the powder feedstock in a bed and/or spraying a metal powder of the powder feedstock towards or on a substrate;
(b) selectively heating a portion of the metal powder above its liquidus temperature, thereby forming a molten pool;
(c) cooling the molten pool, thereby forming a portion of the metal product, wherein the cooling comprises cooling at a cooling rate of at least 100° C. per second; and
(d) repeating steps (a)-(c) until the metal product is completed.

19. The method of claim 17, wherein the feedstock comprises a wire feedstock, wherein the method comprises:
(a) using a radiation source to heat the wire feedstock above its liquidus point, thereby creating a molten pool;
(b) cooling the molten pool at a cooling rate of at least 1000° C. per second; and
(c) repeating steps (a)-(b) until the metal product is completed.

20. The method of claim 17, comprising cooling at a rate sufficient to form at least one precipitate phase, wherein the at least one precipitate phase comprises Ti₃Al.
